(19) United States
(12) Patent Application Publication
(10) Pub. No.: US 2004/0015514 A1
(43) Pub. Date: Jan. 22, 2004

(54) Method and system for managing data objects

(76) Inventors: Austin Melton, Sugar Bush Knolls, OH (US); Laura Bartolo, Kent, OH (US); Christopher J. Woolverton, Kent, OH (US); Monica Strah, Denville, NJ (US); Cathy Lowe, Ravenna, OH (US); Louis Feng, Kent, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/368,301

(22) Filed: Feb. 18, 2003

Related U.S. Application Data
(60) Provisional application No. 60/369,951, filed on Apr. 3, 2002.

(51) Int. Cl. G06F 17/00

(52) U.S. Cl. 707/103 R

(57) ABSTRACT

A system and method for managing a plurality of data objects with a database complying with the Dublin Core metadata schema. The database includes a plurality of tables including at least one metadata table containing metadata records conforming to the Dublin Core metadata schema and relating to data objects stored in one of the tables. In another embodiment, an electronic scientific laboratory notebook for managing a plurality of scientific laboratory notebook data objects including a computing device communicating with a system for managing the plurality of scientific laboratory notebook data objects. Data objects may be entered, searched and viewed through the electronic notebook. In another embodiment, a computer-readable medium containing a data structure for managing a plurality of data objects with a plurality of tables complying with the Dublin Core metadata schema. The data structure may include a modified relational database incorporating hierarchical structure between tables.

### CROSS-REFERENCE TO RELATED APPLICATIONS

This application claims the benefit of U.S. Provisional Application No. 60/369,951 filed Apr. 3, 2002.

### FIELD OF THE INVENTION

The present invention relates generally to the computerized data management arts, and, more particularly, to a system, method and database design using the Dublin Core metadata schema in the management of data. It finds particular application in the management of scientific laboratory notebook data objects.

### BACKGROUND OF THE INVENTION

Advanced information technology and interdisciplinary research efforts are helping scientists create new knowledge and make breakthrough discoveries leading to an improved quality of life, enhanced productivity, and increased economic competitiveness. A consequence of these research efforts is massive amounts of rich digital multimedia information, the majority of which is largely heterogeneous in nature. To use this heterogeneous information effectively in academic, industrial and public settings, novel technologies are needed to organize, access, and communicate the research results.

For example, data collected within a scientific laboratory and entered into a scientific laboratory notebook presents considerable limitations. Such data is often heterogeneous. Furthermore, the sequential logging of data by individual researchers makes it difficult to locate needed information at a later time and to integrate data with other concurrent experiments in the laboratory. This is especially problematic as multiple investigators pursue parallel research tracks, record in separate notebooks, and attempt to unite various experimental results to form conclusions.

It is known in the art to digitize certain heterogeneous data, including results of the type entered into a scientific laboratory notebook, in order to facilitate access thereto. Such digital access enables researchers to use, re-use and integrate data generated within a laboratory with certain data collected in other laboratories, but the heterogeneous nature of such data does not facilitate consistent, cohesive and reliable access to all of the data, even when in a digital form. Furthermore, capture of such data across multiple and divergent domain databases, each incorporating different structure and relation, makes the gathering, managing, exchanging and presenting of such multidisciplinary, multi-institutional data on a global scale difficult, if not impossible.

Metadata is structured information that describes, explains, locates or otherwise makes it easier to retrieve, use or manage an information resource. Among other known metadata schemas, the Dublin Core Metadata Initiative, began in 1995, was designed to bring together information scientists, digital library researchers, content providers and text-markup experts to improve discovery standards for information resources. The Dublin Core Metadata Initiative was originally developed to be a simple and concise schema to describe web-based documents.

It is known in the art to apply the Dublin Core Metadata Initiative schema to web-based resources. See, for example, case studies detailed at the Dublin Core Metadata Initiative website at http://dublincore.org. While the Dublin Core Metadata Initiative schema has been used successfully to describe a wide variety of completed web-based resources, such a metadata schema has not been used with a real-world, on-going heterogeneous pool of data such as data which comprises a scientific laboratory notebook or a series of related scientific laboratory notebooks in use during research. There exists a need to apply such a metadata schema to data in a laboratory setting to capture, manage, exchange and present a creator's digital description of data objects from the capturing, early stages of the information life cycle up through the presenting, later stages thereof. The concepts herein, however, are not limited to the scientific community, but also meet a growing need in all segments of today's mobile society for tools for allowing users to transform heterogeneous information into useable knowledge and communicate this knowledge effectively.

### SUMMARY OF THE INVENTION

In accordance with one embodiment of the present invention, a system for managing a plurality of data objects is provided. The system includes a database having a plurality of tables including at least one metadata table, metadata tagging logic and data object placement logic. The metadata table includes a plurality of metadata records each conforming to a dublin core metadata schema. Each of the plurality of metadata records relates to a data object stored in the plurality of tables. The database may be a modified relational database and may include hierarchically related tables. The system may further include metadata search logic, search result coordinating logic and output logic.

In accordance with another aspect of the invention, an electronic scientific laboratory notebook for managing a plurality of scientific laboratory notebook data objects is provided. The electronic notebook includes a computing device communicating with a system having metadata classification logic and a database having a plurality of tables including at least one metadata table. The system may also include metadata tagging logic, data object placement logic, metadata search logic and output logic. The metadata table includes a plurality of metadata records each conforming to a dublin core metadata schema. The computing device may be a portable device and may communicate with the system via wireless communication.

In accordance with another aspect of the invention, a computer-readable medium containing a data structure for use in allocating memory is provided. The data structure includes a database having a plurality of tables including at least one metadata table. The metadata table includes a plurality of metadata records each conforming to a dublin core metadata schema. The database may be a modified relational database and may include hierarchically related tables.

In accordance with another aspect of the invention, a method for managing a plurality of scientific laboratory notebook data objects with a dublin core metadata schema is provided. The method includes the steps of gatherings data objects, tagging at least one data object with metadata, storing the data objects and related metadata, searching the data objects by searching the metadata, and outputting results of the search.

In accordance with another aspect of the invention, a method for populating a database with a plurality of scientific laboratory notebook data objects is provided. The database includes a plurality of tables including at least one metadata table. The metadata table includes a plurality of metadata records each conforming to a dublin core metadata schema. The method includes the steps of obtaining at least one data object, providing metadata regarding the data object, and submitting the data object and the related metadata to the database.

In accordance with another aspect of the invention, a method for accessing a database having a plurality of scientific laboratory notebook data objects is provided. The database includes a plurality of tables including at least one metadata table. The metadata table includes a plurality of metadata records each conforming to a dublin core metadata schema. The method includes the steps of submitting at least one data object search parameter having at least one value for at least one metadata element included in the metadata record and receiving the data objects which have related metadata records which have at least one element value which matches a submitted search parameter.

An advantage of the present invention is that a system and method is provided which facilitates gathering, managing, exchanging and presenting heterogeneous data objects from a plurality of sources. A further advantage of the present invention is that a pool of heterogeneous data objects may be effectively searched. A still further advantage of the present invention is that a plurality of scientific laboratory notebook data objects may be gathered, searched and shared among multiple users.

Yet an additional advantage of the present invention is that an electronic scientific laboratory notebook is provided. The electronic scientific laboratory notebook allows the gathering of heterogeneous scientific laboratory notebook data objects. The electronic scientific laboratory notebook further allows the searching of such data objects. A still further advantage of the present invention is that a portable, wireless electronic scientific laboratory notebook is provided, facilitating a researcher's access to heterogeneous laboratory data from inception through board presentation.

These and other aspects and advantages of the present invention will be apparent to those skilled in the art from the following description of the preferred embodiments in view of the accompanying drawings.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to example the principles of this invention.

FIG. 1 is an exemplary overall system diagram of a system for managing a plurality of data objects in accordance with one embodiment of the present invention;

FIG. 2 is an exemplary database table diagram in accordance with one embodiment of the present invention;

FIG. 3 is an exemplary. database table diagram in accordance with one embodiment of the present invention;

FIG. 4 is an exemplary table relation diagram in accordance with one embodiment of the present invention;

FIG. 5 is an exemplary data relation in accordance with one embodiment of the present invention;

FIG. 6 is an exemplary data relation in accordance with one embodiment of the present invention;

FIG. 7 is an exemplary system diagram of metadata tagging logic in accordance with one embodiment of the present invention;

FIG. 8 is an exemplary metadata record in accordance with one embodiment of the present invention; and

FIG. 9 is an exemplary data entry form in accordance with one embodiment of the present invention;

FIGS. 10-17 are exemplary process diagrams of a system for managing a plurality of data objects in accordance with one embodiment of the present invention.

### DETAILED DESCRIPTION OF THE INVENTION

The following includes definitions of exemplary terms used throughout the disclosure. Both singular and plural forms of all terms fall within each meaning. Except where noted otherwise, capitalized and non-capitalized forms of all terms fall within each meaning:

As used herein, “logic” is used generically and includes but is not limited to hardware, software and/or combinations of both to perform a function.

As used herein, “software” is used generically and includes but is not limited to one or more computer executable instructions, routines, algorithms, modules or programs including separate applications or from dynamically linked libraries for performing functions as described herein. Software may also be implemented in various forms such as a servlet, applet, stand-alone, plug-in or other type of application. Software can be maintained on various computer readable mediums as known in the art.

As used herein, “network” is used generically and includes but is not limited to the Internet, intranets, Wide Area Networks, Local Area Networks and transducer links such as those using Modulator-Demodulators (modems).

As used herein, “computer-readable medium” is any medium that contains computer readable information. “Computer-readable medium,” for example, includes electronic, magnetic, optical electromagnetic, infrared, or semiconductor media. More specific examples include but are not limited to a portable magnetic computer diskette such as floppy diskettes or hard drives, a random access memory (RAM), a read-only memory (ROM), an erasable programmable read-only memory, or a portable compact disk.

As used herein, “data object” is used generically and includes but is not limited to an instance or collection of data or information. “Data objects,” for example, include text, still images, data sets, video, audio and multimedia.

As used herein, “scientific laboratory notebook data object” is any data object which may be included within, or be related to, a scientific laboratory notebook and the research project with which the scientific laboratory notebook relates. “Scientific laboratory notebook data objects,” for example, include project descriptors which capture general descriptions of past, present and planned objects; experimental design concepts which set forth experiment goals; lists of procedures and materials used in actual experiments; specific procedural components; results papers including drafts and finished papers; data tables and graphs illustrating experiment results; and images and datasets showing results of certain materials and methods used.

As used herein, “relational database” is used generically and includes but is not limited to a collection of data organized as a set of formally-described tables from which the data can be accessed in many different ways without having to reorganize the set of tables.

As used herein, “modified relational database” is used generically and includes but is not limited to a relational database which includes defined structure among some or all of the set of tables which comprise the relational database. A “modified relational database,” for example, includes a relational database which includes a hierarchical, parent/child relationship between a group of tables within the relational database.

As used herein, “table” is used generically and includes but is not limited to a data structure used to organize information. A “table” may organize related information into a plurality of records and, as used herein in relation to a relational database, is used interchangeably with “relation.”

As used herein, “metadata” is used generically and includes but is not limited to structured information that describes, explains, locates or otherwise makes it easier to retrieve, use or manage an information source.

As used herein, “metadata table” is a table which contains metadata. A “metadata table,” for example, may include metadata organized into a plurality of metadata records.

As used herein, “record” is used generically and includes but is not limited to a set of related data.

As used herein, “metadata record” is a record which contains metadata. A “metadata record,” for example, may include metadata relating to a single data object.

As used herein, “related” is used generically and includes but is not limited to the state of an instance, item or object being linked to, pointed to or associated with another instance, item or object. “Related,” for example, denotes the existence of an association between a metadata record and a data object wherein the metadata record contains metadata describing the data object. Such an association is manifested in any suitable manner, including but not limited to use of a field within the metadata record to uniquely identify the data object or use of a pointer within the metadata record to point to a data object. “Related,” for further example, denotes the existence of an association between tables of a database. Such an association is manifested in any suitable manner, including but not limited to use of a hierarchical, parent/child structure. For further example, a metadata table may be “related” to another table within a database by virtue of the metadata within the metadata table being related to a record or a plurality of records within the other table.

As used herein, “schema” is used generically and includes but is not limited to organization and structure of data, including standards related thereto. A metadata “schema,” for example, includes standards defining the organization and structure of the metadata, including recognized elements of the metadata and element refinements.

As used herein, “dublin core metadata schema”, in lower-case letters except when at the beginning of a sentence, is any metadata schema which is in compliance with or conforming to the metadata standard defined by the Dublin Core Metadata Initiative as approved by the American National Standards Institute in conjunction with the National Information Standards Organization currently acknowledged as national standard ANSI/NISO Z39.85-2001. Exemplary Dublin Core Metadata Initiative metadata standards, including standard metadata elements and element refinements, are available at http://dublincore.org. The phrase “Dublin Core” is a registered United States trademark, number 2,519,654, registered to OCLC Online Computer Library Center, 6565 Frantz Road, Dublin, Ohio 43017.

As used herein, “dublin core elements”, in lower-case letters except when at the beginning of a sentence, is any set of elements which is in compliance with or conforming to a dublin core metadata schema. “Dublin core elements,” for example, may include title, subject, description, source, language, relation, coverage, creator, publisher, contributor, rights, date, type, format and identifier.

As used herein, “metadata-related data object” is any data object which is related to metadata or a metadata record.

As used herein, “metadata-related table” is any table which contains data which is related to metadata or a metadata record, or any table which is related to a metadata table.

As used herein, “non-metadata-related table” is any table which is not a metadata-related table.

As used herein, “computing device” is any computer which is capable of communicating with a system for managing a plurality of data objects as described herein. “Computing device,” for example, includes but is not limited to a desktop computer, a laptop computer or a personal data assistant which is capable of networking with a system of the present invention. A “computing device” may be portable, and may communicate with a system of the present invention by any suitable means, including but not limited to wireless communication.

In an embodiment, the present invention is directed to a method, system and database design for managing a plurality of scientific laboratory notebook data objects. In another embodiment, the present invention is directed to an electronic scientific laboratory notebook for managing a plurality of scientific laboratory notebook data objects. In these embodiments, the present invention is intended to replicate the pragmatic functionality of a print scientific laboratory notebook, while providing additional functionality regarding data identification, retrieval, organization and presentation. Although the present invention is described in terms of management of scientific laboratory notebook data objects and an electronic scientific laboratory notebook, those skilled in the art will readily appreciate that the invention will find application in any type of information management setting involving the management of heterogeneous data objects, for example, in the management of heterogeneous data objects contained in multiple offices and multiple record keeping systems of a company.

It is not uncommon for an institution, such as a higher education institution, to sponsor or otherwise be involved in multiple scientific research projects at once. Many of these research projects are multi-disciplinary, coordinating the research efforts of multiple groups of people at multiple locations using varying data retrieval and storage systems. During the laboratory research phases of such projects, many researchers create data objects relating to their individual research projects. Such data objects are often stored in a laboratory notebook. Oftentimes, multiple laboratory notebooks are used for a single study.

Many people related to the research projects need to have access to some or all of the notebooks and the data objects therein. Laboratory researchers need to enter data objects. Project overseers need to review data objects. Project leaders need to organize and interpret data objects. Others need to present data objects in other settings, such as to potential commercializers or to the board of the funding university. Still others need to access and manage data objects across multiple research projects, such as university administrators and university budget personnel.

In an embodiment, the present invention is directed to a method and system for managing this heterogeneous group of scientific laboratory notebook data objects and to an electronic notebook for accessing such a system. Individual data objects relating to the research projects which usually are stored in a written lab notebook are tagged upon generation with metadata and digitally stored in the system along with their associated metadata. These data objects and their associated metadata are stored in a modified relational database which can be accessed by multiple users. The metadata associated with each tagged data object conforms to a dublin core metadata schema, facilitating functional metadata for the heterogeneous group of data objects.

Users wishing to access data objects within the database can search the database via the metadata contained therein. Access can be by an electronic scientific laboratory notebook, including a laptop or a personal data assistant (a “PDA”). For example, using a laptop, a lab researcher who has just created a data object can access a system of the present invention, tag the data object with metadata conforming to a dublin core metadata schema, and upload the data object and the metadata into the system. Also using a laptop, a research supervisor can access the system and search for data objects via entering search parameters for matches with values entered into individual elements of each metadata record associated with a data object. Using a PDA, an executive can access the system to retrieve relevant data objects for a presentation to a board of directors relating to a research project using a system of the present invention.

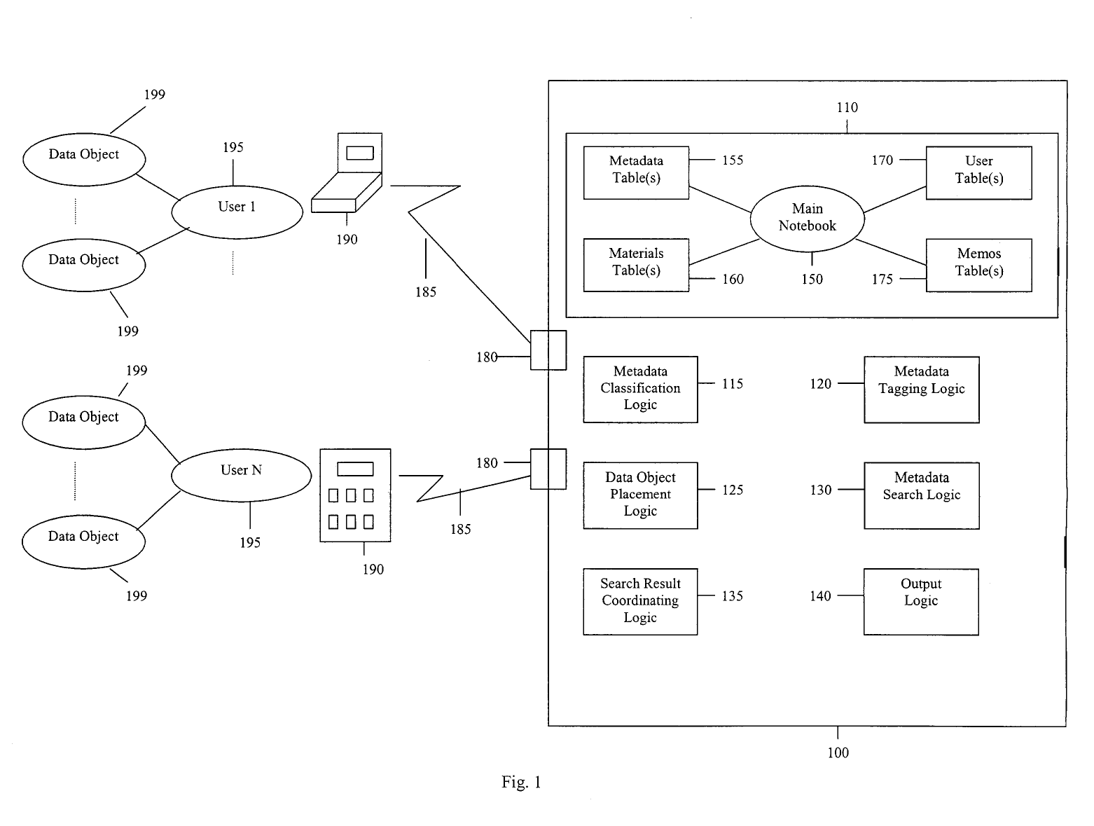

With reference to FIG. 1, an overview of a system for managing a plurality of data objects 100 is shown. In this embodiment, the system 100 includes database 110 and may further include any or all of metadata classification logic 115, metadata tagging logic 120, data object placement logic 125, metadata search logic 130, search result coordinating logic 135 and output logic 140. System 100 exists on any suitable computer, computer system or related group of computer systems known in the art. In an embodiment, system 100 resides upon a server computer or server computer system which is connected by at least one input/output port 180 to any suitable communication network 185. In an embodiment, communication network 185 is a local area network connecting a plurality of computers via any suitable networking protocol, including but not limited to Ethernet. In another embodiment, communication network 185 is the Internet and system 100 comprises server software capable of communicating with client computers via the Internet via any suitable protocol, including but not limited to HTTP. System 100 is embodied in any suitable programming language or combination of programming languages, including database managers and SQL.

Database 110 is any suitable database for storing data objects and metadata relating thereto, and is embodied in any suitable database program, including but not limited to database software offered by Oracle®. In an embodiment, database 110 is implemented by any suitable database management system known in the art, including but not limited to PostgresSQL and Oracle®. In an embodiment, database 110 is a relational database. In an embodiment, database 110 is a modified relational database.

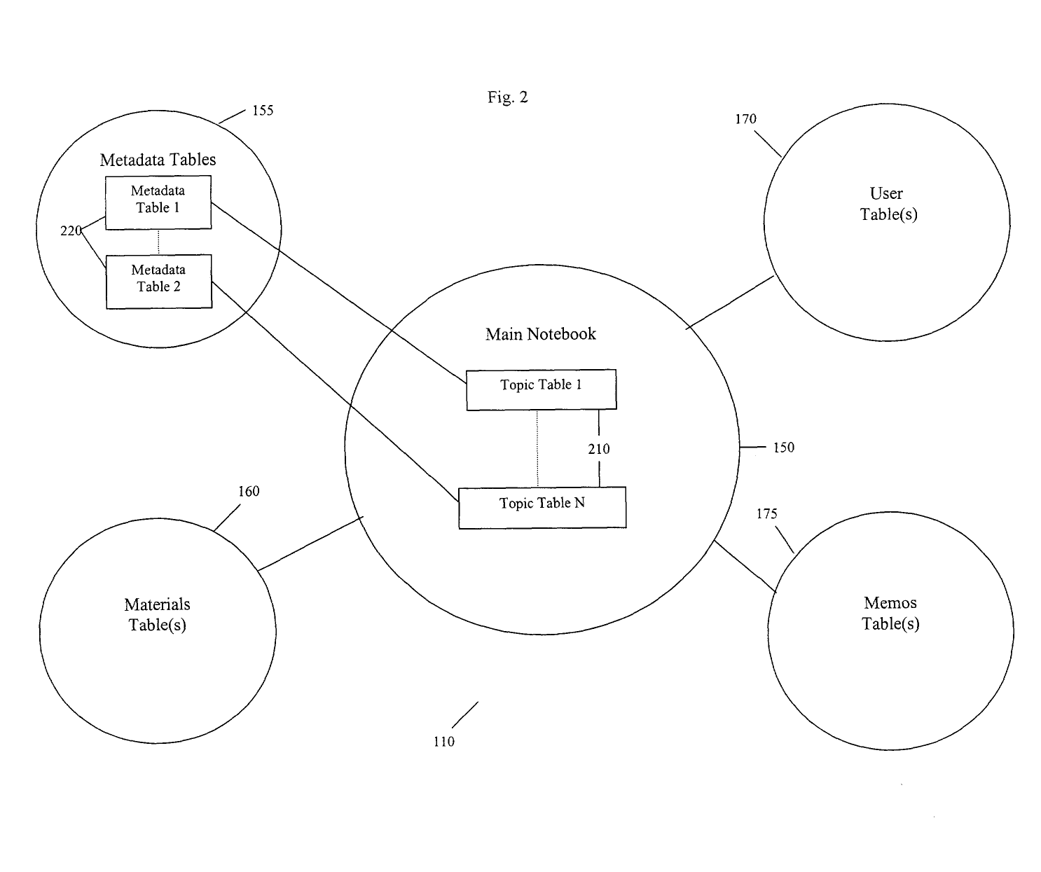

The structure and functions of database 110 will be described with reference to FIGS. 2 through 6 and with further reference to an embodiment of the present invention wherein system 100 includes tables and structures relating to management of scientific laboratory notebook data objects for access by an electronic scientific laboratory notebook of the present invention. While database 110 will be described with reference to such an embodiment, one skilled in the art will readily appreciate that the disclosure herein additionally applies to any other suitable system for managing heterogeneous data objects. One skilled in the art will also appreciate that the database structures and constructs disclosed herein may be modified accordingly to apply to the specific parameters of any other such suitable system.

With reference to FIG. 2, the organization of database 110 begins with at least one topic table, or relation 210. Database 110 may comprise a plurality of topic relations 210. Generally, a topic relation 210 exists for each research topic which will provide data objects for management by a system of the present invention. A metadata table, or relation, 220 is related to, or associated with, each topic relation 210.

Database 110 is a modified relational database including a plurality of tables which are grouped as main notebook 150, metadata table group 155 and, optionally, materials table group 160, user table group 170 and memos table group 175. Each table which comprises database 110 is related to at least one other table in database 110.

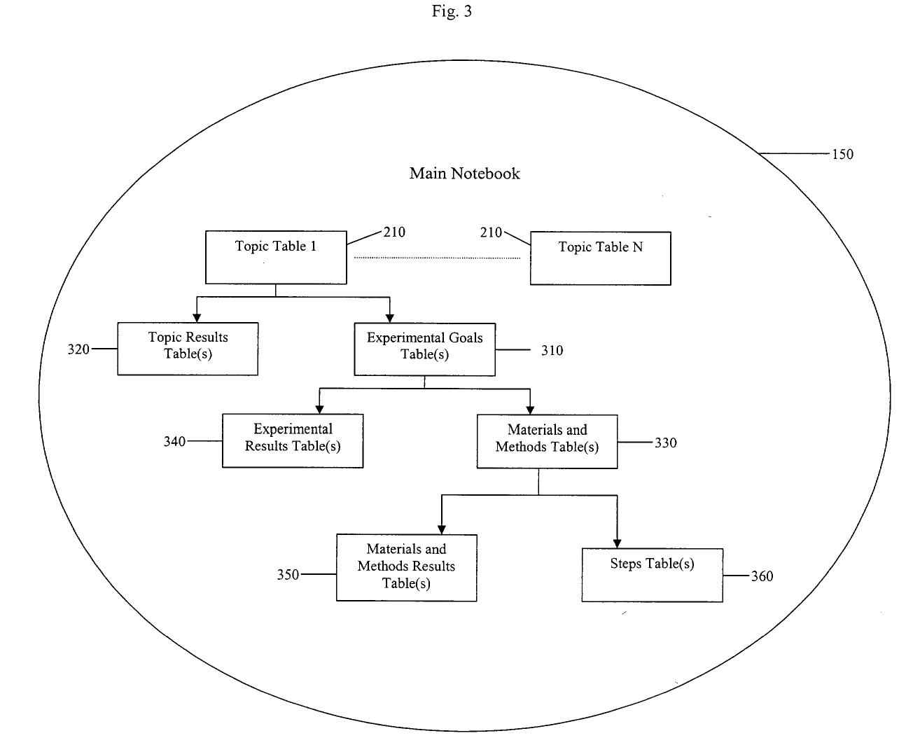

The main notebook 150 contains information which is most central to a system of the present invention. Referring to FIGS. 2 and 3, for each research topic that has an associated topic relation 210, main notebook 150 generally includes a plurality of related tables for storing scientific laboratory notebook data objects related to the research project of each topic relation 210. Main notebook 150 includes any suitable number and structure of tables for storing data objects related to a topic relation 210. In an embodiment, main notebook 150 includes for each topic relation 210 at least one topic results table 320, at least one experimental goals table 310, at least one experimental results table 340, at least one materials and methods table 330, at least one materials and methods results table 350, and, optionally, at least one steps table 360.

Scientific laboratory notebook data objects are placed topically in a table of main notebook 150. In an embodiment, project description data objects, which capture general descriptions of past, present and planned projects, are placed in topic table 210. Experimental design concept data objects specific to a given research project are placed in experimental goals table 310. Procedures and materials used list data objects are placed in materials and methods table 330. Results paper data objects, including draft and finished papers, are placed in topic results table 320. Data table and graph data objects are placed in experimental results table 340. Images and dataset data objects are placed in materials and methods results table 350. Optionally, specific procedural component data objects are placed in steps table 360. While the structure and nature of the tables in main notebook 150 have been described with relation to an embodiment, one skilled in the art would appreciate that any suitable structure and label for tables which contain data objects relating to a research project may be used. Furthermore, one skilled in the art would appreciate that any suitable classification scheme could be used to determine which scientific laboratory notebook data objects are grouped with other data objects in any particular table.

With further reference to FIG. 3, the tables of main notebook 150 are further related with any suitable structure. In an embodiment, main notebook 150 tables are related hierarchically. In an embodiment, each research topic represented in main notebook 150 includes a hierarchical relationship including a first, second, third and fourth level of hierarchy. The levels of hierarchy are characterized by a parent-child relationship wherein each parent-level table has at least one child-level table related thereto, and each child-level table has one parent-level table related thereto. Higher level tables may be related to an unlimited number of lower level tables. In an embodiment, the first level of hierarchy includes a topic table, the second level of hierarchy includes a topic results table and an experiment goals table, the third level of hierarchy includes an experimental results table and a materials and methods table, and the fourth level of hierarchy includes a material and method results table. Under this hierarchical structure, the topic results table and the experiment goals table are children of the topic table, the experiment results table and the materials and methods table are children of the experiment goals table, and the materials and methods results table is a child of the materials and methods table. Optionally, the steps table is a child of the materials and methods table.

Such a structure allows multiple child results tables to be related to a parent table. For example, a single research topic (stored in a topic table) may have multiple results papers associated therewith (each stored in a topic results table associated with the topic table). In an additional example, a procedure employed with a research topic (stored in a material and methods table) may have numerous resulting images and datasets associated therewith (each stored in a material and method results table associated with the particular material and methods table). Additional structural relationships between scientific laboratory notebook data objects are thus created and maintained. While the current embodiment has been illustrated with four levels of hierarchy, each level containing specific tables, one skilled in the art will appreciate that any suitable number of hierarchical levels may be used, and that any suitable allocation of tables within a given level of hierarchy may also be used.

Referring again to FIG. 2, database 110 optionally includes supplementary tables groups materials table group 160, user table group 170 and memos table group 175. Supplementary tables support research projects by archiving additional data objects which relate to the data objects contained within the main notebook 150 and further support the research project. In an embodiment, materials data objects containing detailed materials information, such as material safety data sheets, specification sheets, and materials lot analyses are placed in materials table group 160. Basic contact information data objects, including user authentication and access rights, are placed in user table group 170. Memo-type data objects, including correspondence, equipment issues, and notes for future experiments, are placed in memos table group 175.

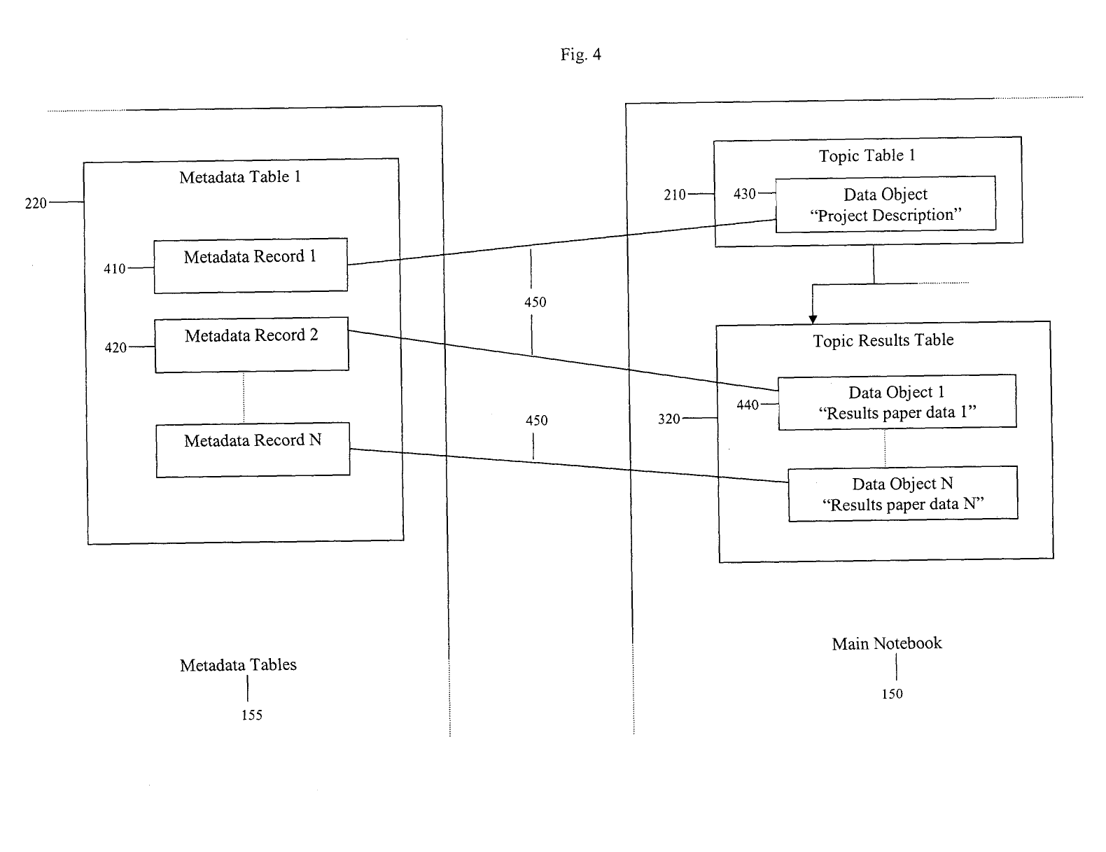

As previously noted, database 110 includes metadata tables group 155 having a metadata table 220 related to each topic table 210 in main notebook 150. With reference to FIG. 4, each metadata table 220 has a plurality of metadata records 410, 420, etc. A metadata record is associated with, or related to 450, every data object contained in main notebook 150 except data objects contained within steps tables 360 (with reference to FIG. 3) of main notebook 150. Each metadata record contains metadata describing the data object with which the metadata is related. Each metadata record further contains a mechanism 450 for identifying the data object with which it is associated. Any suitable association mechanism 450 known to one skilled in the art may be used. Exemplary association mechanisms include a pointer or use of a field of the metadata record to contain an address to or a unique identifier of the data object with which the metadata is associated.

For example, data object “Project Description” 430 is placed in Topic Table 1 210. Data object 430 is related 450 to metadata record 410 placed in metadata table 1 220. Metadata record 410 contains metadata associated with, or describing, data object 430. Likewise, data object “Results paper data 1” 440 is placed in Topic Results Table 320 and is related 450 to metadata record 420 placed in metadata table 220.

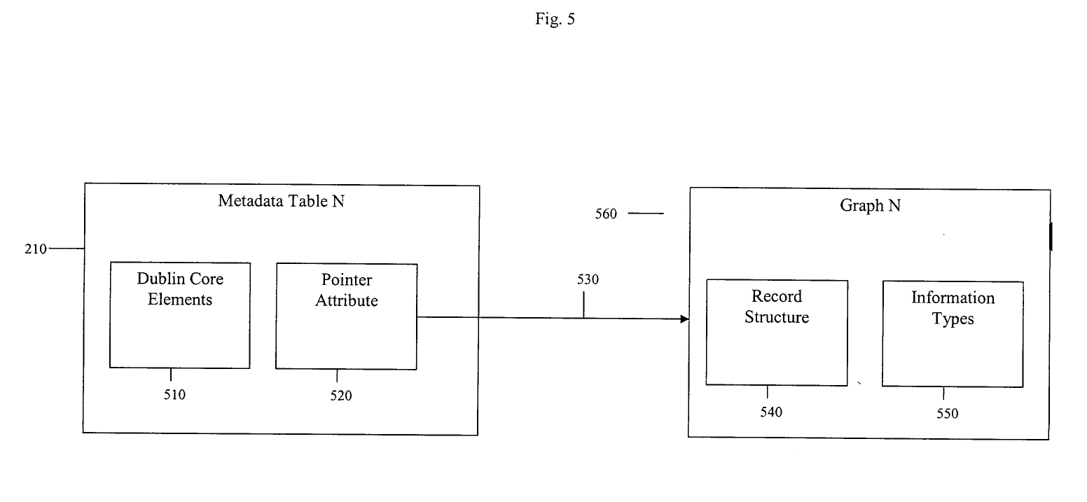

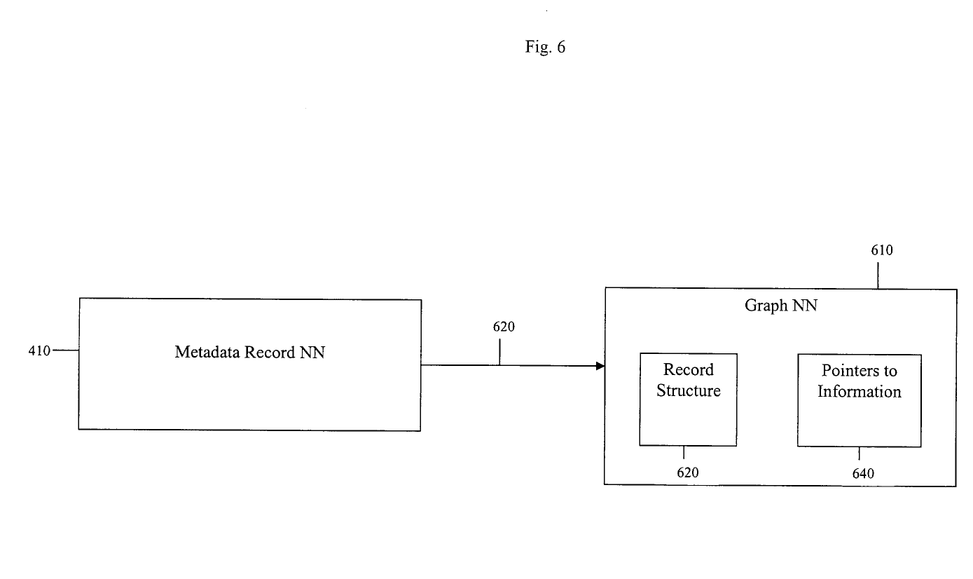

With reference to FIG. 5, in an embodiment, the attributes of a metadata relation 210 include dublin core elements 510, as described below, and a pointer attribute 520. The information stored in pointer attribute 520 is a pointer 530 to a graph 560 which shows the relation's record structure 540 and information types 550. With reference to FIG. 6, in an embodiment, for each metadata record 410, a graph 610 is associated 620 therewith. Graph 620 has nodes which are pairs with the first component being a descriptor (record structure) 610 and the second component being a pointer to information 640. The descriptors may characterize the entity parts and subdivisions. For example, a data object such as a lab report may include charts, tables, and text, and a data object such as a multimedia presentation may include video, music and text. The edges of graph 610 show how the parts of subdivisions fit together to form the whole entity, for example, the whole multimedia presentation or the whole lab report. The metadata record may include information regarding the coordination of multiple data objects in order to create a single data object.

Referring again to FIG. 4, each metadata record 410 in metadata table 220 is related to a data object 430 in main notebook 150. Each metadata record in metadata table 220 conforms to a dublin core metadata schema. In an embodiment, each metadata record in metadata table 220 includes at least one data field for each of a plurality of dublin core elements. In an embodiment, the dublin core elements include the following elements: title, subject, description, source, language, relation, coverage, creator, publisher, contributor, rights, date, type, format and identifier. In another embodiment, the dublin core elements include the following elements: title, creator, subject, description, date, type, format, identifier, language and relation.

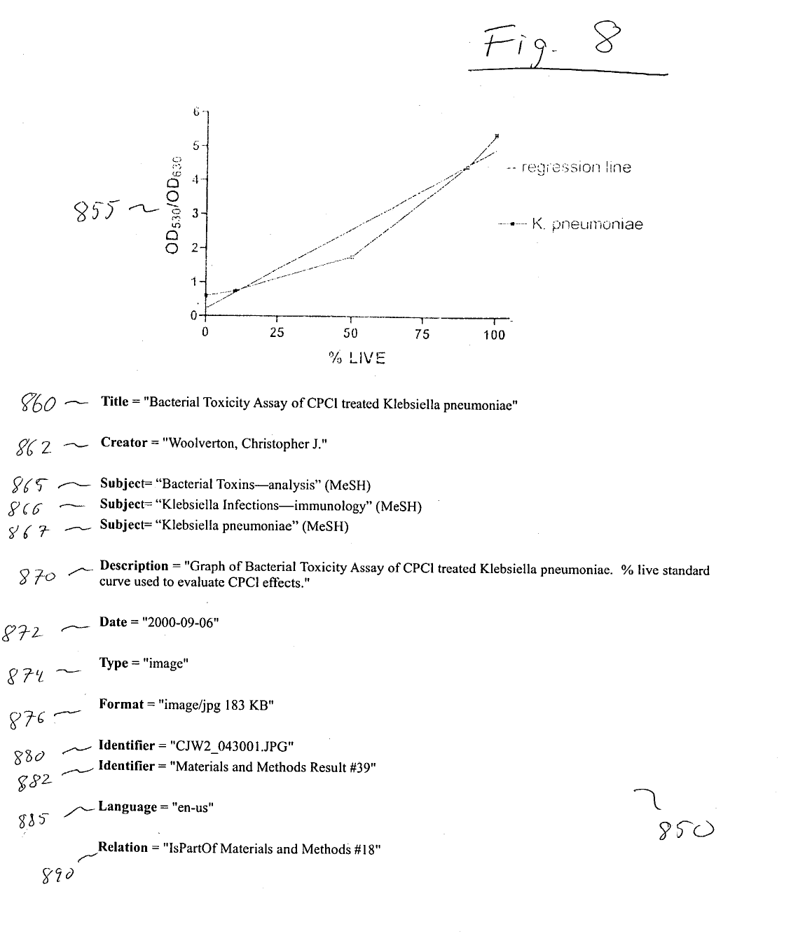

An exemplary printout of an exemplary metadata record is illustrated in FIG. 8. With reference to FIG. 8, the exemplary metadata record 850 is related to data object 855 illustrated at the top of the printout. The exemplary metadata record contains metadata regarding data object 855 contained in a plurality of dublin core elements, including title 860, creator 862, three subject fields 865, 866 and 867, description 870, date 872, type 874, format 876, two identifier fields 880 and 882, language 885 and relation 890. A metadata value has been entered and subsequently printed out for each of the listed dublin core elements. For example, data object 055 is of the type “image” with a title “Bacterial Toxicity Assay of CPCI treated Klebsiella pneumoniae” and with a description “Graph of Bacterial Toxicity Assay of CPCI treated Klebsiella pneumoniae. % live standard curve used to evaluate CPCI effects.” Each data object in main notebook 150 is thus described with metadata including the dublin core elements set forth in FIG. 8.

The dublin core elements, and a dublin core metadata schema, are broad and flexible enough to facilitate description of broad range of heterogeneous data objects. Furthermore, use of data entered into dublin core elements facilitates distinguishment between data objects. For example, it is of value to a user to be able to distinguish whether a data object is a lab report or a paper. In an embodiment, the dublin core element “type” is used for this purpose. By looking at the value of the “type” element in a dublin core metadata schema metadata record, a user can begin to identify the genre of the resource. However, since the “type” element is limited to nine approved terms, a more complete classification will be included in the “description” element when the nine “type” terms are insufficient. For example referring to FIG. 8, the value of the “type” element is “image,” which informs a user that the data object is an image, but does not tell the user whether the image is a picture, a drawing, a table, a graph, etc. The value of the “description” element, however, clearly informs a user that the data item is a graph, and further informs the user regarding the nature of the graph.

The value of a certain dublin core element also informs a user regarding the related data object's location within main notebook 150 and any relationships between the data object and other data objects. In the example of FIG. 8, the second “identifier” element informs the user that data object 855 has been placed in the materials and methods results table #39. From this a user can ascertain that data object 855 is of a type consistent with image or dataset data objects. The “relation” element informs the user that data object 855 is part of materials and methods table #18. Since materials and methods results tables are children to materials and methods tables, a user can ascertain that data object 855 is one component of possibly multiple data objects which comprise the procedures and materials used list data object which comprises materials and methods table 18.

Referring again to FIG. 1, as previously noted, system 100, in addition to database 110, may include any or all of metadata classification logic 115, metadata tagging logic 120, data object placement logic 125, metadata search logic 130, search result coordinating logic 135 and output logic 140.

Metadata classification logic 115 is any suitable step, process, function or series of steps, processes and functions known in the art for classifying a data object as a metadata-related data object or not as a metadata-related data object. In an embodiment wherein database 110 includes both metadata-related tables, such as tables within main notebook 150, and non-metadata-related tables, such as the supplementary tables, a threshold determination regarding the classification of a data object may be made. If metadata is not to be created regarding the data object, then a metadata record need not be created and the data object can be placed in a non-metadata-related table. If metadata is to be created, a metadata record is created and the data object is placed in a metadata-related table. In an embodiment, metadata classification logic 115 further includes any suitable step, process, function or series of steps, processes and functions known in the art for receiving a determination from a user as to whether a data object is classified as a metadata-related object. In an embodiment, metadata classification logic 115 further includes any suitable step, process, function or series of steps, processes and functions known in the art for classifying a data object based upon user-provided table placement information. In this embodiment, metadata classification logic 115 includes logic for associating the identity of a table in database 110 with a classification status. Upon receiving the identity of the table in which a data object is to be placed, metadata classification logic 115 determines if the identified table is of a class which requires a related metadata record. If this determination is positive, the data object is classified as a metadata-related data object. If this determination is negative, the data object is not classified as a metadata-related data object.

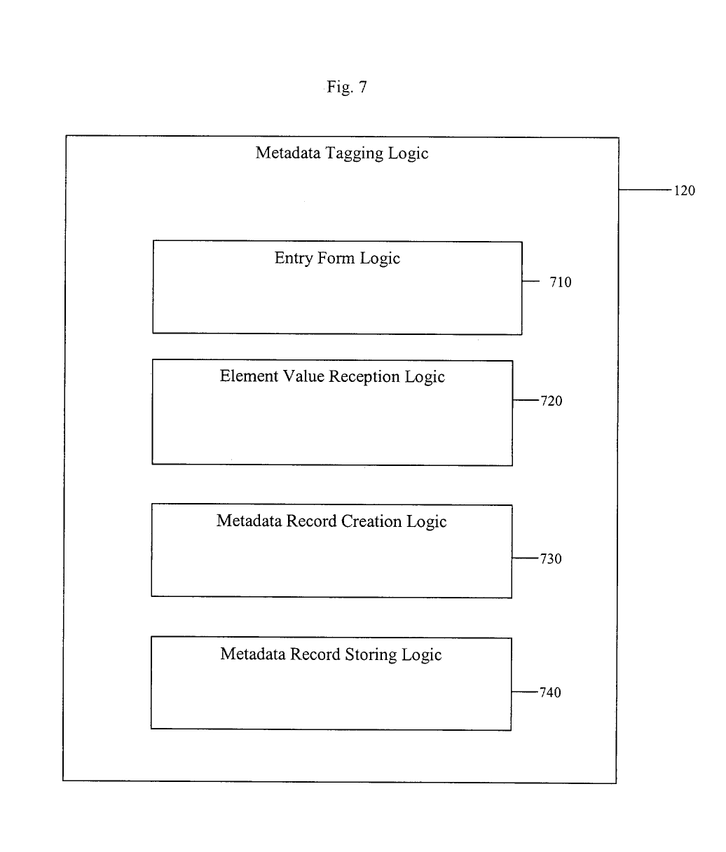

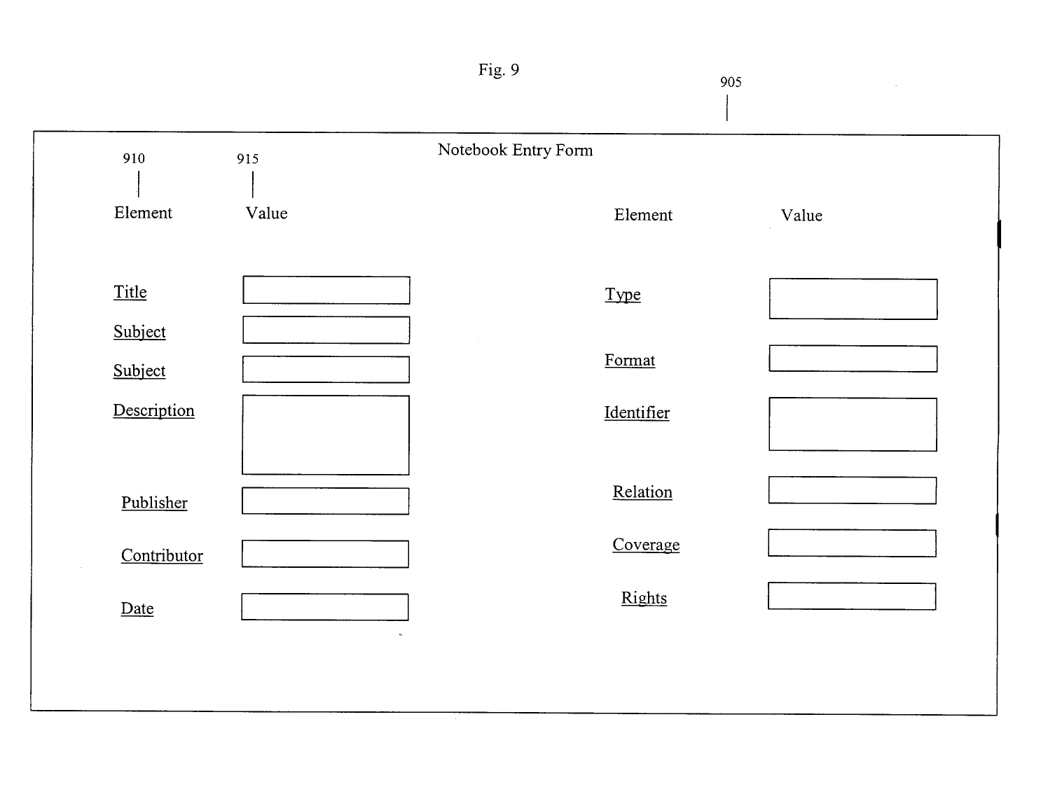

Metadata tagging logic 120 is any suitable step, process, function or series of steps, processes and functions known in the art for tagging a data object with metadata. With reference to FIG. 7, in an embodiment, metadata tagging logic 120 optionally includes entry form logic 710, element value reception logic 720, metadata record creation logic 730 and metadata record storing logic 740. With additional reference to FIG. 9, entry form logic 710 is any suitable step, process, function or series of steps, processes and functions known in the art for providing an entry form to a user to facilitate entry of metadata. FIG. 9 provides an exemplary electronic notebook entry form 905 for receiving metadata. The electronic notebook entry form 905 may be provided by any suitable mechanism. In an embodiment, electronic notebook entry form 905 is provided by server system 100 as HTML software code which is interpreted by a client-side computing device of a user using a web browsing software program, such as, for example, Microsoft® Internet Explorer®, to present electronic notebook entry form 905 to the user. Electronic notebook entry form 905 provides a user with a list of dublin core elements 910 which are included as fields within a metadata record which will relate to a data object. Value entry fields 915, each associated with an included element, are also provided for facilitating entry of at least one value for each listed dublin core element. A user may thus enter a value for any dublin core element supported in a metadata record. In this manner, system 100 can control the nature of information entered by a user by limiting a user to inputting values for a restricted pool of dublin core elements (for example, only the dublin core elements listed in 905). A user is also guided as to what metadata information should be inputted regarding a data object. While FIG. 9 illustrates an exemplary electronic notebook entry form, it will be understood that any suitable entry form may be used, including any suitable combination and sequence of dublin core elements and element input mechanisms.

Element value reception logic 720 is any suitable step, process, function or series of steps, processes and functions known in the art for receiving at least one value for at least one dublin core element relating to a data object. In an embodiment, element value reception logic 720 includes receiving the dublin core element values entered by a user into electronic notebook entry form 905. Metadata record creation logic 730 is any suitable step, process, function or series of steps, processes and functions known in the art for creating at least one metadata record based upon received element values. A metadata record is typically created by assigning each received element value to a field of the metadata record. Record creation is well known to one skilled in the art. Metadata record storing logic 740 is any suitable step, process, function or series of steps, processes and functions known in the art for storing at least one metadata record in the metadata table. It will understood that any or all of these logics may be included in metadata tagging logic 120.

Referring again to FIG. 1, data object placement logic 125 is any suitable step, process, function or series of steps, processes and functions known in the art for placing a data object in a table of the database. Record placement within a table is well known to one skilled in the art. Typically, if it has been determined by metadata classification logic 115 that a data object is not classified as a metadata-related data object, data object placement logic 125 places the data object in a non-metadata-related table. The identity of the non-metadata-related table is determined by any suitable mechanism. In an embodiment, the identity of the non-metadata-related table is determined by the user. For example, a user may designate a data object as a memo suitable for memos table 175, and data object placement logic 125 accordingly places the data object in memos table 175. In an embodiment, the identity of the non-metadata-related table is determined by the nature of the data object. For example, system 100 is pre-programmed to identity certain characteristics of a data object as being associated with a certain identity. For example, all memos may have headers which identify them as memos.

If it has been determined by metadata classification logic 115 that a data object is classified as a metadata-related data object, data object placement logic places the data object in the appropriate metadata-related table. The identity of the appropriate metadata-related table is determined by any suitable mechanism. In an embodiment, the identity of the metadata-related table is determined by the user. For example, a user may enter in an appropriate dublin core element value field the value of the table in which a data object is to be placed, and data object placement logic 125 accordingly places the data object. In an embodiment, upon placing the data object in an appropriate table, data object placement logic 125 returns to metadata tagging logic 120 the unique location of the data object. In this manner, the location of the data object may be stored in the related metadata record by any suitable mechanism. Exemplary mechanisms include use of a pointer to a unique memory location and entry into a metadata record field of a unique value which identifies the location of the data object.

Metadata search logic 130 is any suitable step, process, function or series of steps, processes and functions known in the art for searching database 110. In an embodiment, metadata search logic 130 includes receiving a search parameter. A search parameter includes at least one value for at least one dublin core metadata element included within the metadata records contained in database 110, and such a search parameter can include a range of values. For example, a user may desire to search database 110 for all graphs relating to a particular research paper data object. The user may enter a search parameter indicating that the user wishes to search all metadata records for each metadata record which contains a value in a dublin core element field that indicates that the data object related to the metadata record is a graph. In an embodiment, a user can enter a search parameter based upon values for any of the dublin core elements included in the metadata records. A user can restrict a search to one element, or combine elements and element value parameters to customize a search parameter.

In an embodiment, metadata search logic 130 includes search parameter matching logic. Upon receipt of a search parameter, search parameter matching logic searches through the metadata records contained in the metadata table to determine which, if any, metadata records contain a value which matches the entered search parameter. Such matching logic is well known in the art. While search parameter matching logic has been described in relation to a search of the entire metadata table, one skilled in the art will appreciate that such matching logic may be truncated by searching only portions of the metadata table using mechanisms well known in the art. For example, in an embodiment wherein multiple topic tables exist and a search parameter is limited to a particular research topic, matching logic may only search the metadata table related to the topic table which is related to the research topic identified in the search parameter.

In another embodiment, metadata search logic 130 further includes data object retrieval logic. Upon completion of the matching logic, metadata search logic produces a set of metadata records which contains a value which matched at least one search parameter. For each metadata record in the set, data object retrieval logic retrieves the data object related with each metadata record. Such retrieval is performed by any suitable mechanism. In an embodiment, data object retrieval logic uses the field in the metadata record which indicates the placement of the related data object to determine the location of the related data object and to subsequently retrieve the data object. Data object retrieval logic collects the retrieved data objects in an answer set.

Search result coordinating logic 135 is any suitable step, process, function or series of steps, processes and functions known in the art for coordinating multiple search results. In an embodiment, certain data objects, for example, a final results paper, are comprised of a plurality of other data objects. While a search parameter may call for the final results paper data object, the immediate results of metadata search logic 130 may include only the plurality of component data objects. Search result coordinating logic 135 coordinates the plurality of component data objects into a resulting composite data object by any suitable mechanism known to one skilled in the art. In an embodiment, and referring additionally to FIG. 6, search result coordinating logic 135 accesses graph 610 associated with a data object to determine if component data objects must be retrieved and coordinated in order to return the composite data object. Search result coordinating logic 135 may access record structure 620 to determine the nature of the component data objects, and may further access pointers to information 640 in order to locate and retrieve such data objects.

Output logic 140 is any suitable step, process, function or series of steps, processes and functions known in the art for outputting search results. In an embodiment, output logic 140 outputs results from metadata search logic 130. In another embodiment, output logic 140 outputs results from search result coordinating logic 135. Output logic 140 outputs search results in any suitable manner, including, for example, by providing search results in HTML format viewable to an end user at a computing device. Output logic 140 may further output the contents of any data object retrieved.

Referring again to FIG. 1, using any suitable input/output port 180, system 100 communicates 185 with computing device 190. To a user 195 using a computing device 190, computing device embodies an electronic scientific laboratory notebook. Through computing device 190, a user may access system 100. Through such access, a user may input scientific laboratory notebook data items into system 100. Through such access, a user may search all previously-entered data objects. Through such access, a user may retrieve any data object previously submitted. Computing device 190 thus facilitates activities normally associated with a single or a plurality of written scientific laboratory notebooks, but with the added advantages realized from an electronic scientific laboratory notebook in communication with system 100.

Computing device 190 is any suitable computer capable of communicating with system 100 via any suitable network 185. In an example, computing device 190 is a laptop used by user 195 to enter data objects 199 into system 100. The laptop may be plugged into an Ethernet port available in the laboratory in which the research project is proceeding. In another example, computing device 190 is a PDA used by a user 195 to retrieve data objects 199 from system 100. The PDA may be in communication with system 100 via any suitable wireless network. The PDA may be in use by a user in a boardroom making a presentation and being desirous of retrieving a data object for the purpose of edifying the board regarding the data item.

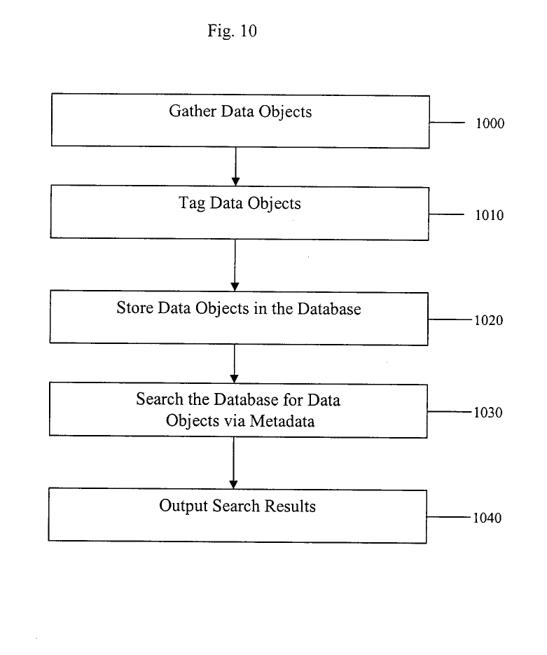

FIGS. 10 through 17 show exemplary methodologies for managing a plurality of scientific laboratory notebook data objects in accordance with embodiments of the present invention. The blocks shown represent functions, actions or events performed therein. If embodied in software, each block may represent a module, segment or portion of code that comprises one or more executable instructions to implement the specified logical function(s). If embodied in hardware, each block may represent one or more circuits or other electronic devices to implement the specified logical function(s). It will be appreciated that computer software applications involve dynamic and flexible processes such that the functions, actions or events performed by the software and/or the hardware can be performed in other sequences different than the one shown.

With reference to FIGS. 10 through 13, a methodology will be described with regard to managing a plurality of scientific laboratory notebook data objects with a dublin core metadata schema. Referring to FIG. 10, at block 1000 data objects are gathered. In an embodiment, the data objects are gathered in digital form. In the event the native form of a data object is not digital, a digital version of the data object is created by any suitable means. For example, if the data object is an analog image, the analog image may be scanned into digital format by a mechanism well known to one skilled in the art. In another embodiment, data objects are gathered which relate to a certain instance or subject. For example, all data objects relating to a particular research project are gathered. For another example, all data objects results from a particular laboratory experiment are gathered.

At block 1010, at least one of the gathered data objects is tagged with metadata conforming to a dublin core metadata schema. The metadata is stored in a metadata record which is related to the data object which the metadata describes. The metadata record is stored in at least one metadata table. In an embodiment, all gathered data objects are tagged with metadata conforming to a dublin core metadata schema.

At block 1020, each of the tagged data objects are stored as a record in at least one table within database 110. At block 1030, the data objects which reside in database 110 are searched. The data objects are searched by searching the metadata records associated with each data object for dublin core element values which match search parameters entered by a user. At block 1040, the results of a search are outputted.

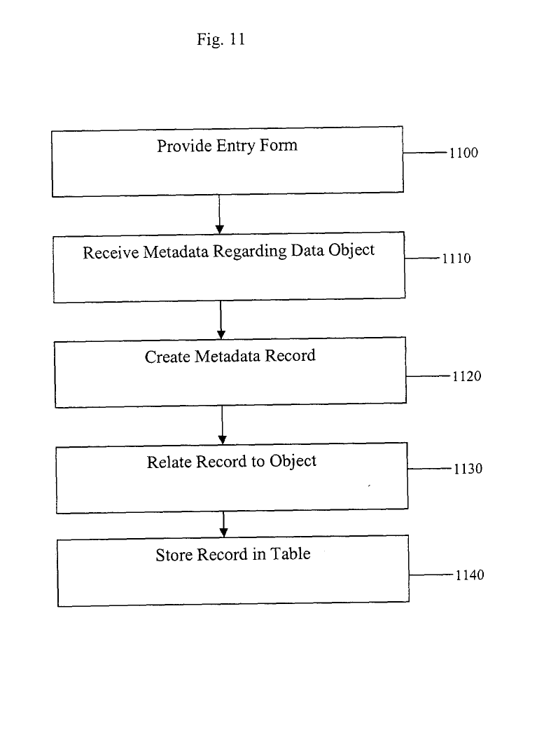

Referring to FIG. 11, in an embodiment, the tagging data objects methodology 1010 further includes any, all or any combination of the methodologies exemplified in FIG. 11. At block 1100, an electronic notebook entry form is provided for obtaining metadata regarding a data object from a user. In an embodiment, the entry form is similar to the entry form exemplified in FIG. 9. At block 1110 metadata regarding a data object is received into the electronic entry form. At block 1120, a metadata record is created including the metadata received. At block 1130, the metadata record is related to the data object. At block 1140, the metadata record is stored in a metadata table.

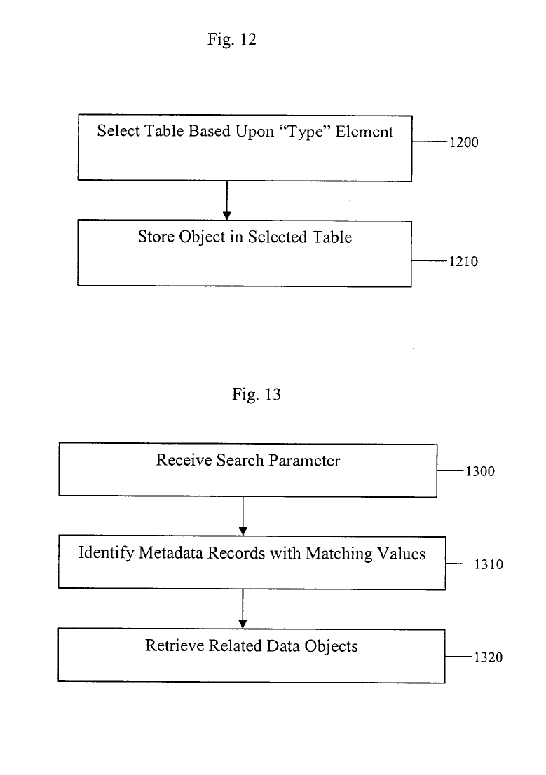

Referring to FIG. 12, in an embodiment, the storing data objects methodology 1020 further includes any, all or any combination of the methodologies exemplified in FIG. 12. At block 1200, a table in which to place a data object is selected. Such selection can be achieved by any suitable methodology. In an embodiment, a table is selected based upon metadata contained within the dublin core element “type” of the metadata record related to the data object. In another embodiment, a table is selected based upon metadata contained within the dublin core element “identifier” of the metadata record related to the data object. At block 1210, the data object is placed, or stored, in the table selected at block 1200.

Referring to FIG. 13, in an embodiment, the storing database searching methodology 1030 further includes any, all or any combination of the methodologies exemplified in FIG. 13. At block 1300, a data object search parameter is received. In an embodiment, the search parameter has a value for at least one dublin core metadata element included within the metadata records. At block 1310, metadata records of the metadata table which have values which match the search parameter are identified. At block 1320, data objects are retrieved from database 110 which are related to the metadata records identified at block 1310.

In an embodiment, a methodology for managing a plurality of scientific laboratory data objects with a dublin core metadata schema further includes coordinating a plurality of component data objects into a resulting data object. In yet another embodiment, the methodology further includes storing each data object which is not tagged in a non-metadata-related table in database 110.

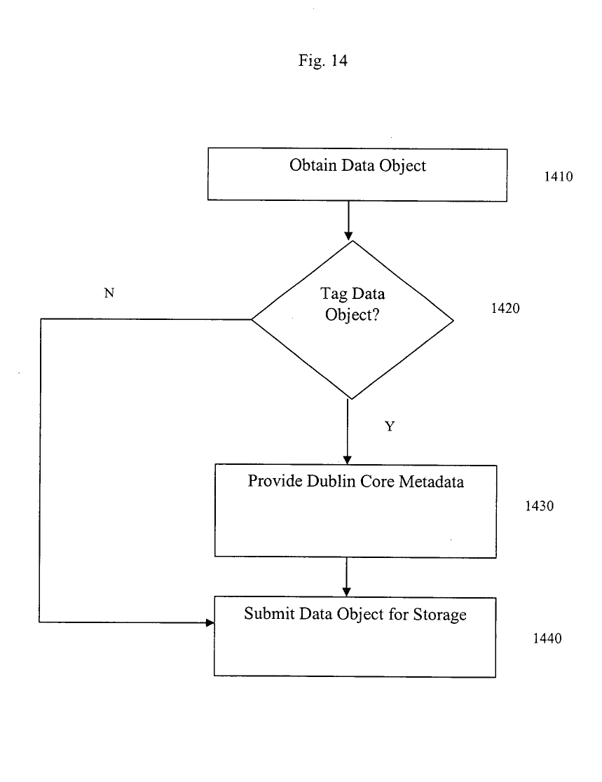

With reference to FIGS. 14 through 16, a methodology will be described with regard to populating a modified relational database with a plurality of scientific laboratory notebook data objects using a dublin core metadata schema. Referring to FIG. 14, at block 1410 data objects are gathered. In an embodiment, the data objects are gathered in digital form. Optionally, at block 1420, it is determined whether a data object will be tagged. If it is determined that a data item will not be tagged, the methodology proceeds to block 1440, described below. If it is determined that a data item will be tagged, the methodology proceeds to block 1430, also described below. The tagging determination is made by any suitable method. In an embodiment, the tagging determination is made by a user depending upon the nature of the data object. For example, if a data object is of a type which is to be placed in a supplementary table, the determination is made not to tag the data object. Conversely, if the data object is of the type which is to be placed in main notebook 150, the determination is made to tag the data object.

At block 1430, metadata which relates to the data object and which conforms to a dublin core metadata schema is provided. At block 1440, the data object is submitted to system 100 for storage in database 110.

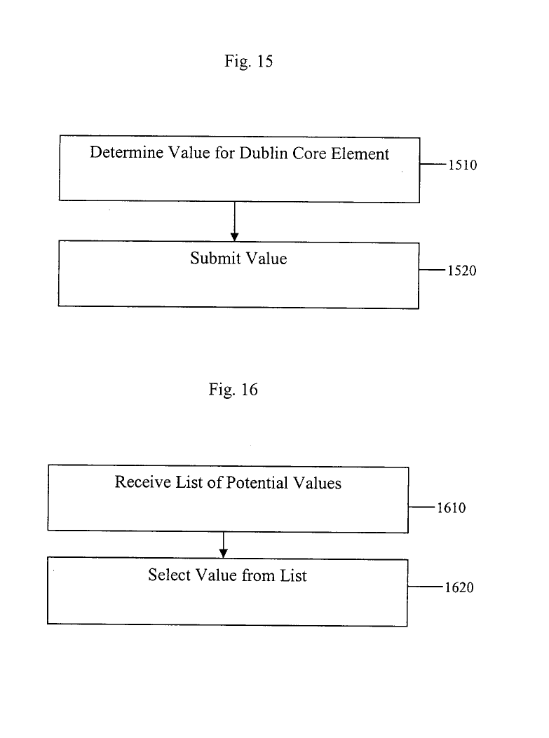

Referring to FIG. 15, in an embodiment, the providing metadata methodology 1430 further includes any, all or any combination of the methodologies exemplified in FIG. 15. At block 1510, a value for each dublin core element in conformance with a dublin core metadata schema is determined. At block 1520, the values determined at block 1510 are submitted to system 100.

Referring to FIG. 16, in an embodiment, the value determination methodology 1510 further includes any, all or any combination of the methodologies exemplified in FIG. 16. At block 1610, a list of potential values for at least one dublin core element is received. Such a list of potential values may be received by any suitable methodology. In an embodiment wherein an electronic notebook entry form of the type exemplified in FIG. 9 is used, a list of potential values may be contained in a “drop-down” menu list. Such a menu list may be related with any element listed on the entry form. Such drop-down menu lists are well-known in the art. In an embodiment, a drop-down menu list is created in HTML which is activated by clicking a down-arrow attached to a value entry field in the entry form. A user may view a drop-down list by clicking on the down arrow. At block 1620, a value of a dublin core element is selected from the list of potential values.

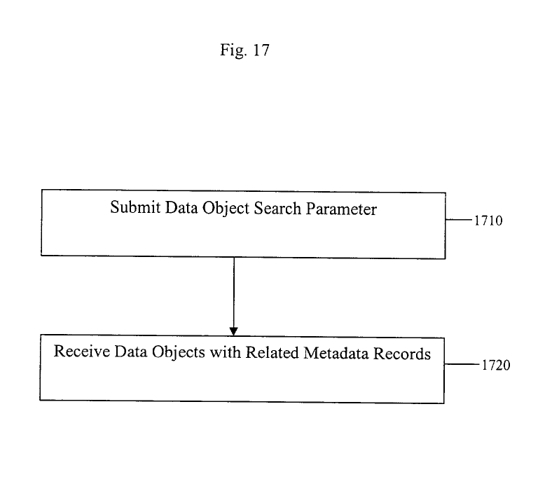

With reference to FIG. 17, a methodology will be described with regard to accessing a modified relational database with a plurality of scientific laboratory notebook data objects using a dublin core metadata schema. At block 1710, a data object search parameter is submitted. In an embodiment, the search parameter includes at least one value for at least one dublin core metadata element included in the metadata records. At block 1720, data objects which are related to metadata records which have at least one element value which matches a submitted search parameter are received.

Although the flow charts of FIGS. 10 through 17 show exemplary orders of execution, it is understood that the order of execution may differ from that which is depicted. Also, two or more blocks shown in FIGS. 10 through 17 may be combined and/or executed concurrently or with partial concurrence. It is understood that all such variations are within the scope of the present invention. Also, the flow charts of FIGS. 10 through 17 is understood by those with ordinary skill in the art to the extent that software and/or hardware can be created to carry out the various logical functions as described herein.

While the present invention has been illustrated by the description of embodiments thereof, and while the embodiments have been described in considerable detail, the scope of the appended claims should not be restricted or in any way limited to such detail. Additional advantages and modifications will readily appear to those skilled in the art. Therefore, the invention, in its broader aspects, is not limited to the specific details, the representative systems, and illustrative examples shown and described. Accordingly, departures may be made from such details without departing from the spirit or scope of the invention disclosed herein.

We claim:

1. A system for managing a plurality of data objects, comprising:
a database having a plurality of tables, wherein each of the data objects is stored in at least one of the tables, and at least one of the tables is a metadata table, the metadata table including a plurality of metadata records, each of the plurality of metadata records conforming to a dublin core metadata schema, and each of the plurality of metadata records related to one of the data objects and containing metadata related thereto;
metadata tagging logic for tagging a data object; and
data object placement logic for placing a data object in a table of the database.

2. The system of claim 1, wherein the database is a modified relational database having a plurality of tables related hierarchically, and wherein the metadata table is related to each of the hierarchically related tables.

3. The system of claim 2, wherein the hierarchically related tables are related by a plurality of hierarchical levels characterized by a parent-child relationship wherein each parent-level table has at least one child-level table related thereto, and each child-level table has one parent-level table related thereto.

4. The system of claim 3, wherein the hierarchical relationship has a first, a second, a third and a fourth level of hierarchy.

5. The system of claim 4, wherein the first level of hierarchy includes a topic table, the second level of hierarchy includes a topic results table and an experiment goals table, the third level of hierarchy includes an experimental results table and a materials and methods table, the fourth level of hierarchy includes a material and method results table, and wherein the topic results table and the experiment goals table are children of the topic table, the experiment results table and the materials and methods table are children of the experiment goals table, and the materials and methods results table is a child of the materials and methods table.

6. The system of claim 1, wherein the metadata of each metadata record includes at least one field for each of a plurality of dublin core elements.

7. The system of claim 6, wherein the plurality of dublin core elements includes title, subject, description, source, language, relation, coverage, creator, publisher, contributor, rights, date, type, format and identifier.

8. The system of claim 6, wherein the plurality of dublin core elements consists of title, creator, subject, description, date, type, format, identifier, language and relation.

9. The system of claim 8 wherein the dublin core type element has a range of values defined by the dublin core metadata schema.

10. The system of claim 9 wherein the dublin core description element provides type-element description.

11. The system of claim 1 wherein each of the plurality of the data objects is related to one of the plurality of metadata records.

12. The system of claim 1 further comprising metadata classification logic for classifying the data object as a metadata-related data object.

13. The system of claim 1 wherein the metadata tagging logic further comprises:
metadata record creation logic for creating at least one metadata record based upon received element values; and
metadata record storage logic for storing at least one metadata record in the metadata table.

14. The system of claim 1 wherein the metadata tagging logic further comprises:
entry form logic for providing at least one form for entering metadata values;
element value reception logic for receiving at least one value for at least one metadata record element;
metadata record creation logic for creating at least one metadata record based upon received element values; and
metadata record storage logic for storing at least one metadata record in the metadata table.

15. The system of claim 1 further comprising metadata search logic for searching the database.

16. The system of claim 1 further comprising search result coordinating logic for coordinating multiple search results.

17. The system of claim 1 further comprising output logic for outputting search results.

18. A system for managing a plurality of data objects, comprising:
metadata classification logic for determining whether to classify the data object as a metadata-related data object;
a database having
a plurality of metadata-related tables, wherein each of the metadata-related data objects is stored in at least one of the metadata-related tables,
at least one metadata table, the metadata table related to each of the plurality of metadata-related tables, the metadata table having a plurality of metadata records,
each of the plurality of metadata records conforming to a dublin core metadata schema, each of the plurality of metadata records related to one of the metadata-related data objects and containing metadata related thereto, and each of the plurality of metadata-related data objects related to one of the metadata records, and
at least one non-metadata-related table, wherein each of the data objects which is not related to a metadata record is stored, and
wherein each of the plurality of metadata-related tables and each of the at least one non-metadata-related tables are related to at least one other of each of the plurality of metadata-related tables or of each of the at least one non-metadata-related tables;
metadata tagging logic for tagging a metadata-related data object; and
data object placement logic for placing a data object in a table of the database.

19. The system of claim 18 wherein the database is a modified relational database and the plurality of metadata-related tables are related hierarchically with a first, a second, a third and a fourth level of hierarchy, the hierarchical relationship characterized by a parent-child relationship wherein each parent-level table has at least one child-level table related thereto, and each child-level table has one parent-level table related thereto, and wherein the first level of hierarchy includes a topic table, the second level of hierarchy includes a topic results table and an experiment goals table, the third level of hierarchy includes an experimental results table and a materials and methods table, the fourth level of hierarchy includes a material and method results table, and wherein the topic results table and the experiment goals table are children of the topic table, the experiment results table and the materials and methods table are children of the experiment goals table, and the materials and methods results table is a child of the materials and methods table.

20. The system of claim 19 wherein the metadata of each metadata record includes at least one field for each of a plurality of dublin core elements, wherein the plurality of dublin core elements includes title, creator, subject, description, date, type, format, identifier, language and relation.

21. The system of claim 18 further comprising:
metadata search logic for searching the metadata-related data objects and output logic for outputting search results.

22. A system for managing a plurality of scientific laboratory notebook data objects relating to a plurality of topics, comprising:
metadata classification logic for determining whether to classify the scientific laboratory notebook data object as a metadata-related data object;
a modified relational database having
a plurality of metadata-related tables, each of the metadata-related tables related hierarchically with a plurality of levels of hierarchy, the hierarchical relationship characterized by a parent-child relationship wherein each parent-level table has at least one child-level table related thereto, and each child-level table has one parent-level table related thereto, and wherein each of the metadata-related data objects is stored in at least one of the metadata-related tables,
at least one metadata table, the metadata table related to each of the plurality of metadata-related tables, the metadata table having a plurality of metadata records, each of the plurality of metadata records conforming to a dublin core metadata schema, each of the plurality of metadata records related to one of the metadata-related data objects and containing metadata related thereto, and each of the plurality of metadata-related data objects related to one of the metadata records, and
a plurality of non-metadata-related tables, wherein each of the scientific laboratory notebook data objects which is not related to a metadata record is stored, and
wherein each of the plurality of metadata-related tables and each of the plurality of non-metadata-related tables are related to at least one other of each of the plurality of metadata-related tables or of each of the plurality of non-metadata-related tables;
metadata tagging logic for tagging a metadata-related data object;
metadata search logic for searching the metadata-related data;
data object placement logic for placing a data object in a table of the database; and
output logic for outputting search results.

23. The system of claim 22 wherein the hierarchical relationship among the metadata-related tables includes a first, a second, a third and a fourth level of hierarchy, wherein the first level of hierarchy includes a topic table, the second level of hierarchy includes a topic results table and an experiment goals table, the third level of hierarchy includes an experimental results table and a materials and methods table, the fourth level of hierarchy includes a material and method results table, and wherein the topic results table and the experiment goals table are children of the topic table, the experiment results table and the materials and methods table are children of the experiment goals table, and the materials and methods results table is a child of the materials and methods table.

24. The system of claim 23 wherein scientific laboratory notebook data objects include at least one project description, at least one experiment design concept, at least one procedures and materials used list, at least one result paper, at least one data table or graph, and at least one image or dataset, wherein:
all project description data objects are placed in a topic table, all experiment design concept data objects are placed in a experiment goals table, all procedures and materials used list data objects are placed in a materials and methods table, all results paper data objects are placed in a topic results table, all data table or graph data objects are placed in an experimental results table, and all image or dataset data objects are placed in a materials and method results table.

25. The system of claim 22 wherein the plurality of non-metadata-related tables includes at least one steps table, at least one materials table, at least one memos table and at least one users table.

26. The system of claim 25 wherein scientific laboratory notebook data objects include at least one specific procedural component, at least one material specification sheet, at least one set of contact information regarding a researcher, and at least one correspondence or note, wherein:
all specific procedural component data objects are placed in a steps table, all material specification sheet data objects are placed in a materials table, all correspondence or note data objects are placed in a memos table, and all contact information regarding a researcher data objects are placed in a users table.

27. An electronic scientific laboratory notebook for managing a plurality of scientific laboratory notebook data objects, the electronic notebook comprising a computing device communicating with a system for managing the plurality of scientific laboratory notebook data objects, the system including:
metadata classification logic for determining whether to classify the scientific laboratory notebook data object as a metadata-related data object;
a database having
a plurality of metadata-related tables, wherein each of the metadata-related data objects is stored in at least one of the metadata-related tables,
at least one metadata table, the metadata table related to each of the plurality of metadata-related tables, the metadata table having a plurality of metadata records,
each of the plurality of metadata records conforming to a dublin core metadata schema, each of the plurality of metadata records related to one of the metadata-related data objects and containing metadata related thereto, and each of the plurality of metadata-related data objects related to one of the metadata records, and
at least one non-metadata-related table, wherein each of the scientific laboratory notebook data objects which is not related to a metadata record is stored, and
wherein each of the plurality of metadata-related tables and each of the at least one non-metadata-related tables are related to at least one other of each of the plurality of metadata-related tables or of each of the at least one non-metadata-related tables;
metadata tagging logic for tagging a metadata-related data object;
data object placement logic for placing a data object in a table of the database;
metadata search logic for searching the metadata-related data objects; and
output logic for outputting search results to the electronic notebook.

28. The electronic notebook of claim 27 wherein the computing device is portable and communication with the system is wireless.

29. A computer-readable medium containing a data structure for use in allocating memory, the data structure containing:
a database having a plurality of tables, wherein each of the data objects is stored in at least one of the tables, and at least one of the tables is a metadata table, the metadata table including a plurality of metadata records, each of the plurality of metadata records conforming to a dublin core metadata schema, and each of the plurality of metadata records related to one of the data objects and containing metadata related thereto.

30. The computer-readable medium of claim 29, wherein the database is a modified relational database having a plurality of tables related hierarchically, and wherein the metadata table is related to each of the hierarchically related tables.

31. The computer-readable medium of claim 30, wherein the hierarchically related tables are related by a plurality of hierarchical levels characterized by a parent-child relationship wherein each parent-level table has at least one child-level table related thereto, and each child-level table has one parent-level table related thereto.

32. The computer-readable medium of claim 31, wherein the hierarchical relationship has a first, a second, a third and a fourth level of hierarchy.

33. The computer-readable medium of claim 32, wherein the first level of hierarchy includes a topic table, the second level of hierarchy includes a topic results table and an experiment goals table, the third level of hierarchy includes an experimental results table and a materials and methods table, the fourth level of hierarchy includes a material and method results table, and wherein the topic results table and the experiment goals table are children of the topic table, the experiment results table and the materials and methods table are children of the experiment goals table, and the materials and methods results table is a child of the materials and methods table.

34. The computer-readable medium of claim 29, wherein the metadata of each metadata record includes at least one field for each of a plurality of dublin core elements.

35. The computer-readable medium of claim 34, wherein the plurality of dublin core elements includes title, subject, description, source, language, relation, coverage, creator, publisher, contributor, rights, date, type, format and identifier.

36. The computer-readable medium of claim 35, wherein the plurality of dublin core elements consists of title, creator, subject, description, date, type, format, identifier, language and relation.

37. The computer-readable medium of claim 36 wherein the dublin core type element has a range of values defined by a dublin core metadata schema.

38. The computer-readable medium of claim 37 wherein the dublin core description element provides type-element description.

39. The computer-readable medium of claim 29 wherein each of the plurality of the data objects is related to one of the plurality of metadata records.

40. A computer-readable medium containing a data structure for use in allocating memory for storing a plurality of data objects and metadata-related data objects, the data structure containing:
a database having
a plurality of metadata-related tables, wherein each of the metadata-related data objects is stored in at least one of the metadata-related tables,
at least one metadata table, the metadata table related to each of the plurality of metadata-related tables, the metadata table having a plurality of metadata records,
each of the plurality of metadata records conforming to a dublin core metadata schema, each of the plurality of metadata records related to one of the metadata-related data objects and containing metadata related thereto, and each of the plurality of metadata-related data objects related to one of the metadata records, and
at least one non-metadata-related table, wherein each of the data objects which is not related to a metadata record is stored, and
wherein each of the plurality of metadata-related tables and each of the at least one non-metadata-related tables are related to at least one other of each of the plurality of metadata-related tables or of each of the at least one non-metadata-related tables.

41. The computer readable medium of claim 40 wherein the database is a modified relational database and the plurality of metadata-related tables are related hierarchically with a first, a second, a third and a fourth level of hierarchy, the hierarchical relationship characterized by a parent-child relationship wherein each parent-level table has at least one child-level table related thereto, and each child-level table has one parent-level table related thereto, and wherein the first level of hierarchy includes a topic table, the second level of hierarchy includes a topic results table and an experiment goals table, the third level of hierarchy includes an experimental results table and a materials and methods table, the fourth level of hierarchy includes a material and method results table, and wherein the topic results table and the experiment goals table are children of the topic table, the experiment results table and the materials and methods table are children of the experiment goals table, and the materials and methods results table is a child of the materials and methods table.

42. The computer readable medium of claim 40 wherein the metadata of each metadata record includes at least one field for each of a plurality of dublin core elements, wherein the plurality of dublin core elements includes title, creator, subject, description, date, type, format, identifier, language and relation.

43. A computer-readable medium containing a data structure for use in allocating memory for storing a plurality of scientific laboratory notebook data objects and metadata-related scientific laboratory notebook data objects, the data structure containing:
a modified relational database having
a plurality of metadata-related tables, each of the metadata-related tables related hierarchically with a plurality of levels of hierarchy, the hierarchical relationship characterized by a parent-child relationship wherein each parent-level table has at least one child-level table related thereto, and each child-level table has one parent-level table related thereto, and wherein each of the metadata-related data objects is stored in at least one of the metadata-related tables,
at least one metadata table, the metadata table related to each of the plurality of metadata-related tables, the metadata table having a plurality of metadata records,
each of the plurality of metadata records conforming to a dublin core metadata schema, each of the plurality of metadata records related to one of the metadata-related data objects and containing metadata related thereto, and each of the plurality of metadata-related data objects related to one of the metadata records, and
a plurality of non-metadata-related tables, wherein each of the scientific laboratory notebook data objects which is not related to a metadata record is stored, and
wherein each of the plurality of metadata-related tables and each of the plurality of non-metadata-related tables are related to at least one other of each of the plurality of metadata-related tables or of each of the plurality of non-metadata-related tables.

44. The computer-readable medium of claim 43 wherein the hierarchical relationship among the metadata-related tables includes a first, a second, a third and a fourth level of hierarchy, wherein the first level of hierarchy includes a topic table, the second level of hierarchy includes a topic results table and an experiment goals table, the third level of hierarchy includes an experimental results table and a materials and methods table, the fourth level of hierarchy includes a material and method results table, and wherein the topic results table and the experiment goals table are children of the topic table, the experiment results table and the materials and methods table are children of the experiment goals table, and the materials and methods results table is a child of the materials and methods table.

45. The computer-readable medium of claim 44 wherein scientific laboratory notebook data objects include at least one project description, at least one experiment design concept, at least one procedures and materials used list, at least one result paper, at least one data table or graph, and at least one image or dataset, wherein:
all project description data objects are placed in a topic table, all experiment design concept data objects are placed in a experiment goals table, all procedures and materials used list data objects are placed in a materials and methods table, all results paper data objects are placed in a topic results table, all data table or graph data objects are placed in an experimental results table, and all image or dataset data objects are placed in a materials and method results table.

46. The computer-readable medium of claim 43 wherein the plurality of non-metadata-related tables includes at least one steps table, at least one materials table, at least one memos table and at least one users table.

47. The computer-readable medium of claim 46 wherein scientific laboratory notebook data objects include at least one specific procedural component, at least one material specification sheet, at least one set of contact information regarding a researcher, and at least one correspondence or note, wherein:
all specific procedural component data objects are placed in a steps table, all material specification sheet data objects are placed in a materials table, all correspondence or note data objects are placed in a memos table, and all contact information regarding a researcher data objects are placed in a users table.

48. A method for managing a plurality of scientific laboratory notebook data objects with a dublin core metadata schema comprising the steps of:
gathering the data objects in digital form;
tagging at least one data object with metadata conforming to a dublin core metadata schema, whereby the metadata is stored in a metadata record which is related to the data object for which the metadata describes, and wherein the metadata record is stored in at least one metadata table;
storing each of the tagged data objects as a record in at least one of a plurality of tables of a modified relational database, each of the plurality of tables related to the metadata table;
searching the plurality of data objects by searching the metadata records associated with the data objects; and
outputting results of a search.

49. The method of claim 48, the tagging step further comprising the steps of:
providing an entry form for obtaining metadata regarding a data object;
receiving metadata regarding a data object into the entry form;
creating a metadata record from the metadata;
relating the metadata record to the data object; and
storing the metadata record in the metadata table.

50. The method of claim 48, wherein a dublin core metadata schema includes an element type, the storing step further comprising the steps of:
selecting the table in which to store the data object based upon metadata contained within the type element of the metadata record related to the data object; and
storing the data object in the selected table.

51. The method of claim 50, wherein the dublin core metadata schema includes an element identifier, the selecting step further comprising the step of selecting the table in which to store the data object based upon metadata contained within the identifier element of the metadata record related to the data object.

52. The method of claim 48, the searching step further comprising the steps of:
receiving at least one data object search parameter having at least one value for at least one dublin core metadata element included in the metadata records;
identifying the metadata records of the metadata table which have values which match the search parameter; and
retrieving the data objects from the database which are related to each identified metadata records.

53. The method of claim 52, further comprising the step of coordinating a plurality of data objects retrieved from the data base.

54. The method of claim 48, further comprising the step of storing each data object which is not tagged as a record in at least one of a plurality of non-metadata indexed tables of the modified relational database.

55. A method for populating a modified relational database with a plurality of scientific laboratory notebook data objects, the database having a plurality of tables for storing data objects and at least one metadata table having at least one metadata record related to each data object stored in each of the plurality of tables which is metadata-related, each of the metadata records conforming to a dublin core metadata schema, the method comprising the steps of:
obtaining at least one data object in digital form;
providing metadata relating to the data object which complies with the dublin core metadata schema; and
submitting the data object for storage in the database.

56. The method of claim 55, wherein each metadata record includes a plurality of dublin core elements, the providing step further comprising the steps of:
determining at least one value for each dublin core element; and
submitting the value for storage in the metadata record.

57. The method of claim 56, wherein the determining step further comprising the steps of:
receiving a list of potential values for at least one dublin core element; and
selecting a value for the dublin core element from the list.

58. The method of claim 57, wherein the dublin core metadata schema includes an element type, and wherein the list of potential values for the element type is in compliance with the dublin core approved values.

59. The method of claim 57, wherein the dublin core metadata schema includes at least one element identifier, wherein the list of potential values for the element identifier includes each of the plurality of tables in which a data object may be stored.

60. The method of claim 55, further comprising the step of:
determining whether a data object will be tagged.

61. The method of claim 55, wherein each metadata record includes a plurality of dublin core elements including an element relation and wherein the range of potential values for the relation element includes all data objects in the database which are related to a metadata record, the providing step further comprising the step of:
determining at least one value for at least one relation element from the range of potential values.

62. A method for accessing a modified relational database with a plurality of scientific laboratory notebook data objects, the database having a plurality of tables for storing data objects and at least one metadata table having at least one metadata record related to each data object stored in each of the plurality of tables which is metadata-related, each of the metadata records conforming to a dublin core metadata schema, the method comprising the steps of:
submitting at least one data object search parameter including at least one value for at least one dublin core metadata element included in the metadata records; and
receiving the data objects which have related metadata records which have at least one element value which matches a submitted search parameter.
